(19) United States
(12) Patent Application Publication
(10) Pub. No.: US 2025/0317333 A1
(43) Pub. Date: Oct. 9, 2025

(54) RADIO FREQUENCY CIRCUIT CONFIGURATION BASED ON PREDICTED PERFORMANCE PROPERTIES

(71) Applicant: QUALCOMM Incorporated, San Diego, CA (US)

(72) Inventors: Steve Andre BEAUDIN, Fremont, CA (US); Puming FANG, Milpitas, CA (US); Yuxin WANG, San Jose, CA (US); Chia-Hui LIN, San Jose, CA (US); Andrew FRIEFELD, Scotts Valley, CA (US); Asaf DORON, Shoham (IL); Kenneth Marvin GAINEY, Escondido, CA (US); Jerry JOHNSON, San Jose, CA (US)

(21) Appl. No.: 18/625,994

(22) Filed: Apr. 3, 2024

(51) Int. Cl. H04L 25/03; H04B 17/391; H04L 25/02

(52) U.S. Cl. CPC H04L 25/03165; H04B 17/3913; H04L 25/0254

(57) ABSTRACT

Certain aspects of the present disclosure provide techniques for configuring operational properties of a radio frequency (RF) circuit using machine learning models. An example method generally includes calculating a delta between a ground-truth digital baseband signal and a received digital baseband signal. One or more predicted radio frequency (RF) circuit performance properties are generated based at least on the calculated delta and using a machine learning model. One or more parameters of a transmission chain are adjusted for a subsequent wireless signal transmission based on the one or more predicted RF circuit performance properties.

### INTRODUCTION

Aspects of the present disclosure relate to configuring operational parameters of radio frequency (RF) circuits and, more particularly, to using machine learning models to configure operational parameters based on predicted RF circuit performance properties.

RF circuits generally allow for signaling to be converted to and from a radio frequency range for transmission to other devices or processing of signaling received from other devices. Generally, these RF circuits are configured to operate according to various performance metrics and operating limits. For example, RF circuits may be configured (e.g., using various power control techniques) to meet a specified error vector magnitude metric (e.g., a distance between a target point in a signal constellation and a transmitted point in the signal constellation below a threshold level), a spectral mask metric measuring interference to adjacent channels, specific absorption rate metrics, or other performance or regulatory metrics.

### BRIEF SUMMARY

Certain aspects provide a method for radio frequency (RF) circuit configuration. The method generally includes calculating a delta between a ground-truth digital baseband signal and a received digital baseband signal. One or more predicted radio frequency (RF) circuit performance properties are generated based at least on the calculated delta and using a machine learning model. One or more parameters of a transmission chain are adjusted for a subsequent wireless signal transmission based on the one or more predicted RF circuit performance properties.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 illustrates error vector magnitude statistics for a radio frequency (RF) circuit.

FIG. 2 illustrates an RF circuit configurable using machine-learning-model-based parameter calibration and a delta between ground-truth and received digital baseband signals, according to aspects of the present disclosure.

FIG. 3 illustrates a machine learning model for configuring an RF circuit based on machine-learning-model-based parameter calibration, according to aspects of the present disclosure.

FIG. 4 illustrates example operations that may be performed to configure an RF circuit using machine-learning-model-based parameter calibration and a delta between ground-truth and received digital baseband signals, according to aspects of the present disclosure.

FIG. 5 illustrates an example implementation of a processing system in which an RF circuit can be calibrated using machine-learning-model-based parameter calibration and a delta between ground-truth and received digital baseband signals, according to aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for configuring radio frequency (RF) circuits using machine learning techniques.

RF circuits are subject to variability in fabrication and operating parameters that may affect the operation of such integrated circuits. Because of this variability, an RF circuit may be configured using “golden bin” parameters (or other default parameters) associated with a reference sample of the RF circuit. This reference sample of the RF circuit may, for example, be a sample of the RF circuit that does not include fabrication defects or other deviations from a design of the RF circuit. However, the “golden bin” parameters may not allow each sample of the RF circuit to conform to performance or regulatory targets defined for the design of the RF circuit (e.g., error vector magnitude thresholds, spectral mask limitations, emissions limitations, etc.), as each sample of the RF circuit may have different performance properties due to part variability in each of the components of the RF circuit (which may result, for example, from variations in fabrication such as variations in etch depths, metal or oxide layer thicknesses, impurity concentrations, variations in the printed circuit board, variations in the values of external matching components and the like).

Thus, to allow for each sample of an RF circuit to operate in conformity with the performance or regulatory targets defined for the design of the RF circuit, factory calibration can be performed on each sample to minimize, or at least reduce, the operational effects of variation within the RF circuit. However, factory calibration may be a time-consuming process. Further, factory calibration may not account for residual effects of operating conditions and the accuracy of various metrology devices within the RF circuit; for example, factory calibration may not account for changes in operating temperatures and frequencies and for variability in the accuracy of power measurements in each sample of the RF circuit. Thus, in order to prevent a sample of an RF circuit from being overdriven and violating the performance and/or regulatory targets defined for the design of the RF circuit, power control parameters for the RF circuit may be restricted. For example, the maximum allowable commanded power may be adjusted downward based on an a priori defined uncertainty margin so that the RF circuit is not overdriven.

Many radio frequency transmitters use a power control algorithm to control the RF power being transmitted from the device. The power control algorithm may have variations across frequency, temperature, voltage and as well as from part to part variation. Even if a device has been shown to meet its EVM or emission mask targets at a certain commanded power during development testing, backing off or otherwise reducing the allowable transmit power for a given operating mode may be performed to account for the uncertainty or margin of error of the power control algorithm. Generally, the power control algorithms may be implemented as closed-loop systems in which a directional coupler is used to sample the RF signal coming out of the transmitter and feed a portion of this signal back to a calibrated power detector. Even when a closed loop power control algorithm is employed to manage the power control parameters of the RF circuit, part to part variation due to variation in the coupling coefficient of the directional coupler or the RMS power detector may still exist. When performance is less important, an open loop power control algorithm in which power is controlled by using a gain table and golden bin method may be employed.

Aspects of the present disclosure provide techniques and apparatus for configuring RF circuits using dynamically generated parameters. These dynamically generated parameters may be generated by a machine learning model trained to generate these parameters based on a comparison of a ground-truth digital baseband signal and a received version of the digital baseband signal. By using a machine learning model to dynamically generate parameters used to configure an RF circuit, aspects of the present disclosure may improve the performance of RF circuits relative to techniques in which a priori defined parameters (e.g., “golden bin” parameters and a defined uncertainty margin) are used to configure RF circuits. For example, power parameters may be configured for the RF circuit that allow the RF circuit to operate at the highest achievable performance level of the RF circuit and improve the quality of communications performed using the RF circuit (e.g., by transmitting signaling at a higher power that is more likely to result in reception of the signal at a receiving device with fewer retransmission attempts relative to the transmission of signaling based on a priori defined parameters that are based on “golden bin” parameters and defined uncertainty margins).

### Example Radio Frequency (RF) Performance Properties

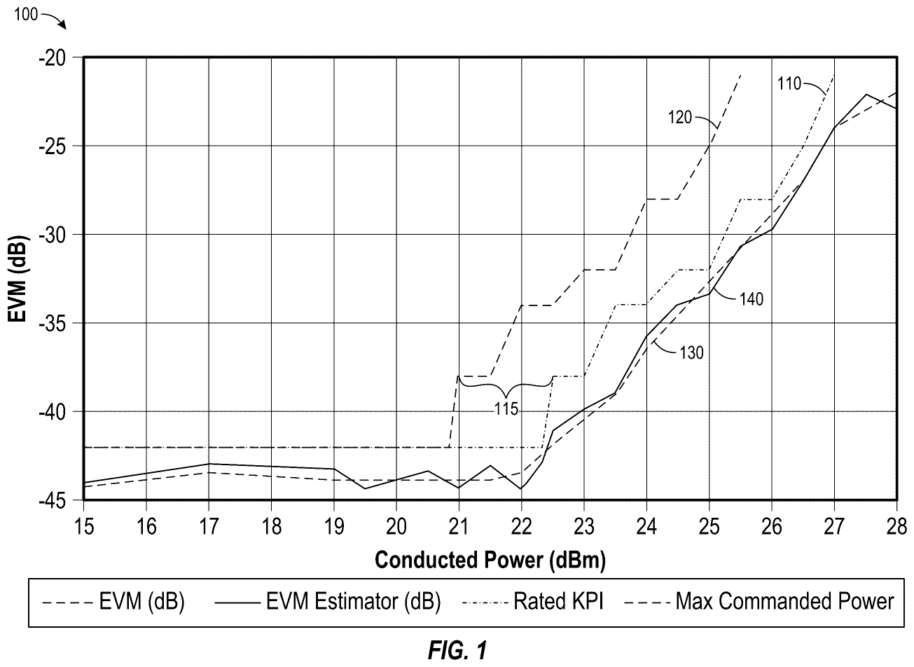

FIG. 1 illustrates a performance graph 100 for a sample of an RF circuit. The performance graph 100 illustrates a plot of error vector magnitude (EVM) in decibels (dB) versus conducted power in decibel-milliwatts (dBm).

Generally, the performance properties of an RF circuit may vary across different samples (corresponding to different builds) of the RF circuit. For example, an RF circuit may be fabricated according to a specified design. However, the fabrication process used to fabricate samples of the RF circuit may have variations due to natural variation in the materials used during fabrication and fabrication techniques. Thus, the properties of each sample of an RF circuit may vary.

During the design process, a minimum level of performance may be determined. This minimum level of performance, also referred to as performance guaranteed over process and illustrated by the line 110 in the performance graph 100, may be determined by design verification testing during development of the RF circuit. As illustrated for this particular graph 100, it may be seen that the EVM guaranteed over process illustrated by the line 110 may be steady up to 22 dBm conducted power and may increase as the conducted power increases (representing a decrease in performance as conducted power increases).

However, the performance guaranteed over process illustrated by the line 110 may not reflect the performance properties of a marginal acceptable sample of the RF circuit or may not reflect the performance properties of a sample of the RF circuit in a particular operating environment. For example, the performance guaranteed over process illustrated by the line 110 may not account for operations in different temperature regimes, frequency ranges, voltages, or the like. To account for these variations, the maximum allowable commanded power, illustrated by the line 120, may be reduced based on an uncertainty metric associated, for example, with closed loop power control (CLPC) for the RF circuit. As illustrated, the maximum allowable commanded power illustrated by the line 120 may be a shifted version of the performance guaranteed over process illustrated by the line 110, represented by the shift 115. In addition, the margin of error of the actual CLPC algorithm may be considered in determining various performance properties of the RF circuit. The performance indicators illustrated by the line 110 is generally determined by characterizing a large sample set of devices using calibrated RF test equipment which can precisely measure and report the actual transmitter power. However, when the device is in use, the actual RF power at which a device is transmitting, versus the commanded power, may be offset by up to the maximum design tolerance of the CLPC algorithm. As such, to ensure the device is not overdriven, the maximum commanded power 120 is generally reduced from the performance guaranteed over process illustrated by the line 110 by an amount corresponding to the uncertainty of the CLPC algorithm.

Both the performance guaranteed over process illustrated by the line 110 and the performance allowable based on the maximum allowable commanded power illustrated by the line 120 generally result in lower performance than that achievable by the RF circuit, illustrated by the actual error vector magnitude (EVM) line 130. For example, to achieve an EVM of less than −40 dB, the conducted power of the RF circuit may be greater than 23 dBm. However, due to the use of a defined backoff relative to performance guaranteed over process, the RF circuit may be restricted to a lower conducted power level (in this example, 21 dBm, according to the line 120). Because the RF circuit may be restricted to a lower conducted power level than that which would actually achieve a given EVM (or other accuracy or performance metric), the RF circuit may not be used to its full capacity. For wireless communication, the ability to transmit a radio frequency signal with a higher power corresponds to increased communications range and/or increased throughput. The potential performance improvement of 2 dB described in the example embodiment above would correspond to an 25% increased range, or a 58% increase in coverage area assuming a line of sight propagation environment.

To configure a sample of an RF circuit to maximize, or at least increase, the performance of the sample of the RF circuit relative to the maximum allowable commanded power based on an a priori defined backoff from the performance guaranteed over process illustrated by the line 110, aspects of the present disclosure use machine learning models to estimate performance properties of the RF circuit based on a delta between a ground-truth digital baseband signal and a received digital baseband signal. Based on the predicted performance of the sample of the RF circuit, the amount of power used to drive the RF circuit may be adjusted to achieve performance that approaches at least the performance guaranteed over process illustrated by the line 110. In some aspects, the performance of the RF circuit configured based on the machine learning techniques discussed herein may, as illustrated by the line 140, approach the actual highest achievable performance of the sample of the RF circuit illustrated by the actual EVM line 130.

While FIG. 1 illustrates RF circuit performance in the scope of EVM, it should be recognized that similar characteristics may be seen using other performance metrics, and different performance metrics can be used in determining an amount of power to use in driving an RF circuit. For example, based on a modulation and coding scheme (MCS) used to transmit signaling via an RF circuit, EVM or spectral mask emission metrics, which are generally associated with an amount of interference generated on bands adjacent to that on which the RF circuit is transmitting, can be used as a benchmark based on which the amount of power to use in driving an RF circuit is determined. At high MCS indices, the amount of power to use in driving the RF circuit may be constrained by EVM statistics. At low MCS indices, EVM targets may be easily achievable, and the amount of power to use in driving the RF circuit may be constrained by spectral mask emission metrics.

### Example Architecture for Machine-Learning-Model-Based Configuration of RF Circuits

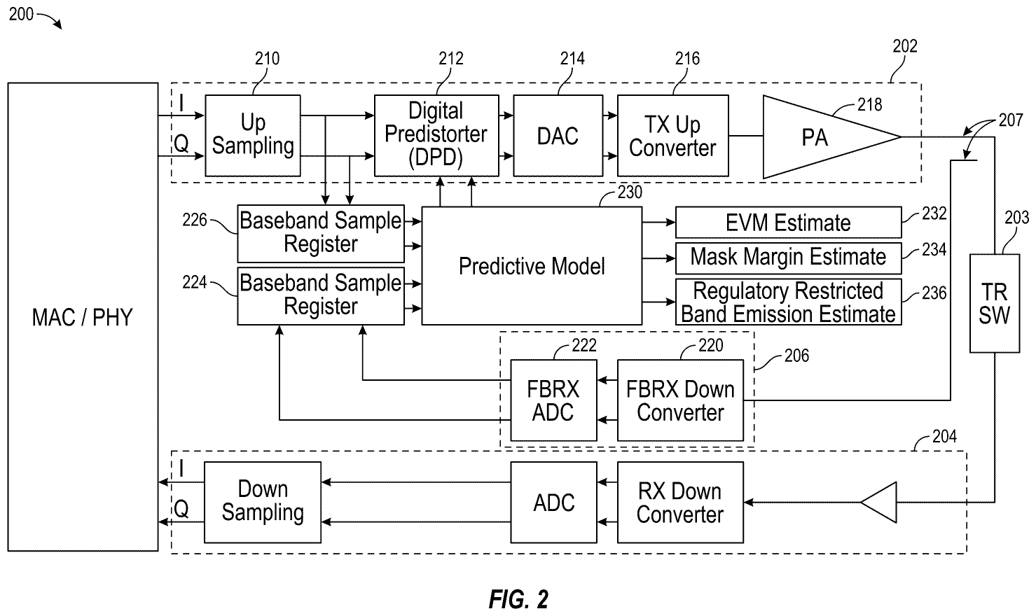

FIG. 2 illustrates an RF circuit 200 configurable using machine-learning-model-based parameter calibration and a delta between ground-truth and received digital baseband signals, according to aspects of the present disclosure.

Generally, the RF circuit 200 includes a transmit chain 202 that is configured to receive a digital baseband signal (e.g., an I/Q signal including in-phase (I) and quadrature (Q) components) from a baseband processor (labeled MAC/PHY in FIG. 2), convert the digital baseband signal into a radio frequency signal, and transmit the radio frequency signal to another device via one or more antennas (not shown) coupled with the RF circuit 200, such as via a transmit/receive switch 203 (labeled “TR SW”) coupled between the transmit chain 202 and the antenna(s). The RF circuit 200 additionally includes a receive chain 204 that is configured to receive a radio frequency signal from a transmitting device via the one or more antenna(s) (and in some cases, the transmit/receive switch 203), downconvert the radio frequency signal to an analog baseband signal, convert the analog baseband signal to a digital baseband signal, and downsample the digital baseband signal to recover a downsampled baseband signal (e.g., an I/Q signal) for processing by the baseband processor. Finally, to allow for dynamic configuration of the RF circuit 200, the RF circuit 200 may additionally include a feedback receive chain (FBRX) 206 which feeds back an RF signal generated along the transmit chain 202 (e.g., via a directional coupler 207) to the RF circuit 200 for use in configuring the RF circuit 200.

As illustrated, the transmit chain 202 includes an upsampler 210, a digital predistorter (DPD) 212, a digital-to-analog converter (DAC) 214, a transmission upconverter 216, and a power amplifier (PA) 218. To generate a radio frequency signal for wireless transmission, the upsampler 210 upsamples a received digital baseband signal to allow the digital baseband signal to be filtered prior to modulation and conversion from a digital signal to an analog signal. The upsampled digital baseband signal may be saved in a baseband sample register 226 representing ground-truth baseband samples for use in training and inferencing using a predictive model 230 (as discussed in further detail below). Additionally, the upsampled digital baseband signal may be predistorted at the predistorter 212 to compensate, at least adjust, for distortion introduced to a signal by the power amplifier 218. After processing in the digital domain by the predistorter 212, the predistorted and upsampled digital baseband signal may be converted from a digital signal to an analog signal by the DAC 214 and upconverted from a baseband signal to a radio frequency signal by the transmission upconverter 216 (e.g., one or more mixer stages). Finally, the radio frequency signal may be amplified by the power amplifier 218 using a commanded power identified (e.g., by a controller, not illustrated in FIG. 2) for use in transmitting signaling from the output of the transmit chain 202 via the antenna(s).

To configure the RF circuit 200, aspects of the present disclosure may utilize the FBRX 206 to determine how well the transmit chain 202 has generated an RF signal relative to the input provided to the transmit chain 202 by the baseband processor. To do so, the RF signal output by the transmit chain 202 may be received at the FBRX 206 and downconverted by an FBRX downconverter 220 into a baseband analog signal. The baseband analog signal may be processed by an FBRX analog-to-digital (ADC) converter 222 to generate a digital baseband signal, which may be stored in another baseband sample register 224. The digital baseband signal stored in the baseband sample register 224 may be compared with the ground-truth digital baseband signal stored in the baseband sample register 226 for use in training the predictive model 230 to predict performance properties of the RF circuit 200 and in using the predictive model 230 to generate such predictions to control various operating parameters of the RF circuit 200. The circuitry incorporated in the FBRX 206 as well as the Baseband Sample Register 226 and Baseband Sample Register 224 may be shared with the DPD 212.

The predictive model 230 may be an a priori trained model that can adapt based on ground-truth samples recorded in the baseband sample register 226 and corresponding received samples in the baseband sample register 224. Generally, the predictive model 230 may be trained during the hardware development process based on ground-truth samples of baseband digital signals, corresponding received samples of baseband digital signals, and recorded performance statistics, such as EVM, mask margin, RF emissions, or the like, collected across a variety of samples of the RF circuit. These recorded performance statistics may be captured, for example, during laboratory testing of samples of the RF circuit (e.g., using calibrated metrology devices). In some aspects, the predictive model 230 may be trained to predict performance properties of the RF circuit 200 and to generate parameters for use by the digital predistorter (DPD) 212 in predistorting an upsampled digital baseband signal prior to amplification by the power amplifier 218.

In some aspects, the predictive model 230 may be an artificial neural network including a number of hidden layers and a single output layer. As an example, the input layer of the artificial neural network may include four neurons: a first neuron may correspond to the in-phase component of a ground-truth digital baseband signal; a second neuron may correspond to the quadrature component of the ground-truth digital baseband signal; a third neuron may correspond to the in-phase component of a received digital baseband signal, and a fourth neuron may correspond to the quadrature component of the received digital baseband signal. The output layer of the predictive model 230 may allow for a prediction of one or more performance properties for the RF circuit (e.g., an EVM estimate 232, an estimated spectral mask margin 234, estimated RF emissions 236 (e.g., at the edge of a band), or the like). In some aspects, the artificial neural network may be a fully connected neural network.

In some aspects, the predictive model 230 can use properties determined based on a comparison between a ground-truth digital baseband signal and a received digital baseband signal (also referred to as a “feedback digital baseband signal”) to estimate the performance properties for the RF circuit 200. For example, a delta between the ground-truth digital baseband signal and the corresponding received digital baseband signal can be provided as input to the predictive model 230. The delta may be, for example, based on aligning time, gain, and phase between the ground-truth digital baseband signal and the corresponding received digital baseband signal. In some aspects, the delta may be a correlation peak between the ground-truth digital baseband signal and the corresponding received digital baseband signal after aligning these signals in time, gain, and phase.

During usage of the RF circuit 200, the RF circuit 200 may capture samples of ground-truth and corresponding received digital baseband signals and feed these samples as input into the predictive model 230 for use in predicting the performance properties of the RF circuit 200. The estimated performance properties generated by the predictive model 230 may be used by a controller (not illustrated in FIG. 2) associated with the RF circuit 200 to identify parameters to apply to the RF circuit 200 for a subsequent transmission. For example, the controller may be configured with a lookup table or other data structure identifying mappings between a maximum allowable power for driving the power amplifier 218 and a modulation and coding scheme (MCS) used for transmissions by the RF circuit 200. If the estimated performance properties generated by the predictive model 230 indicate that the RF circuit 200 has additional power headroom (e.g., where the amount of power used to drive the power amplifier 218 equals the maximum allowable power defined for a given MCS) that can be exploited without violating performance or regulatory thresholds (e.g., without exceeding a target EVM, exceeding a maximum mask margin, exceeding maximum emissions on a particular band, etc.), the controller can allow the amount of power used by the power amplifier 218 to amplify a subsequent radio frequency signal to exceed the maximum allowable power associated with that given MCS.

In some aspects, the ground-truth digital baseband samples in the baseband sample register 226 may correspond to a priori defined reference data, such as a known sequence of preambles or pilot signals. The corresponding received samples in the baseband sample register 224 may be signals received from an adjacent node to the node on which the RF circuit 200 is deployed. To configure operational parameters of the RF circuit of that adjacent node, the predictive model 230 can estimate the performance properties of the RF circuit at the adjacent node based on the ground-truth digital baseband samples and the baseband samples decoded from signaling received from the adjacent node. The estimated performance properties may be fed back to the adjacent node for the adjacent node to use in adjusting the transmission power and/or other operational parameters used to configure the RF circuit at the adjacent node. In some aspects, the estimated performance properties may be provided to the adjacent node via control signaling transmitted to the adjacent node via a base station or access point. In such a case, the estimated performance properties of the adjacent node may be transmitted on an uplink control channel to a base station or access point, and the base station or access point can forward the estimated performance properties to the adjacent node via downlink control signaling. In some aspects, the estimated performance properties may be provided to the adjacent node directly, for example, via a sidelink channel facilitating peer-to-peer communications between nodes in a wireless communications network.

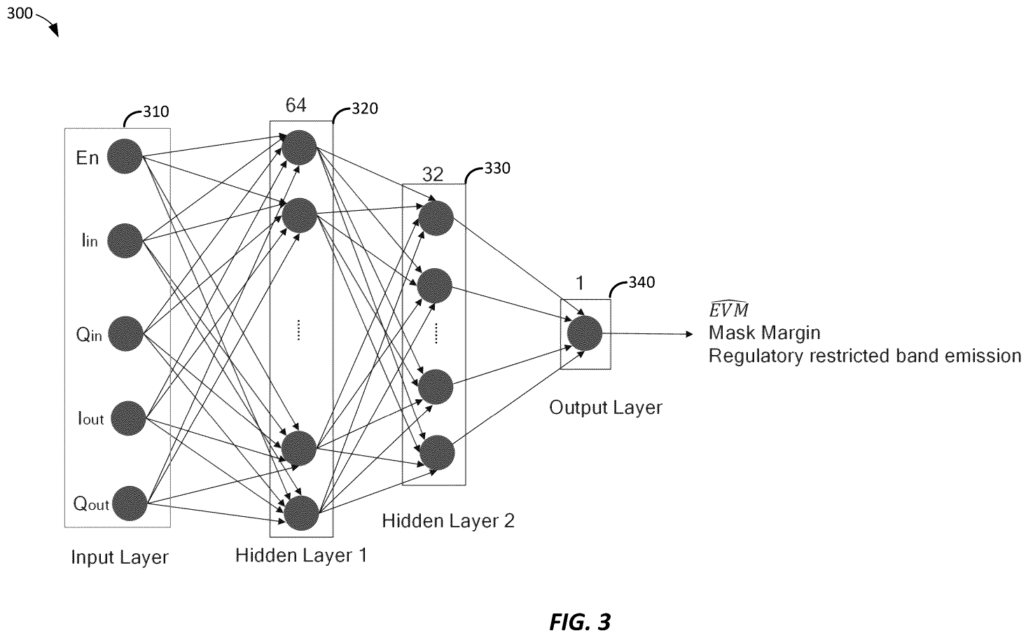

FIG. 3 illustrates an example machine learning model 300 that may be used in machine-learning-model-based parameter calibration, according to aspects of the present disclosure. The machine learning model 300 may correspond, for example, to the predictive model 230 illustrated in FIG. 2.

As illustrated, the machine learning model 300 includes an input layer 310, a first hidden layer 320, a second hidden layer 330, and an output layer 340. The input layer 310 includes a plurality of nodes corresponding to input parameters that are used by the machine learning model 300 to predict the performance properties of an RF circuit. The nodes in the input layer 310 may correspond, for example, to various operational parameters of the RF circuit (labeled En in FIG. 3) and the ground-truth and observed digital baseband signals. The operational parameters may include, for example, a bandwidth of a communications channel on which the RF circuit is transmitting, a measured temperature of the RF circuit, the frequency of the communications channel on which the RF circuit is transmitting, or the like. The ground-truth digital baseband signals may correspond to the Iₒᵤₜ and Qₒᵤₜ nodes of the input layer 310, and the received digital baseband signals may correspond to the Iᵢₙ and Qᵢₙ nodes of the input layer 310.

The nodes of the input layer 310 may be connected to each node in the plurality of nodes in the first hidden layer 320. The first hidden layer 320 may include more nodes than the input layer 310. To generate an output prediction, the nodes of the first hidden layer may be mapped to a reduced set of nodes in the second hidden layer 320 (e.g., having half the number of nodes as that of the first hidden layer 310), and the nodes in the second hidden layer 320 may be reduced to a single node in the output layer 340. Generally, the output layer 340 corresponds to a prediction of performance properties of the RF circuit (e.g., an error vector magnitude (EVM), predicted mask, etc.) which, as discussed above, the RF circuit can use to manage power control parameters for the RF circuit.

Generally, aspects of the present disclosure may allow for the configuration of an RF circuit to achieve the performance of which the RF circuit is capable, as opposed to a backed-off performance level that causes the RF circuit to operate below its actual performance capabilities. For example, assume that a transmitter emission mask margin is calculated as a margin between an a priori defined emission mask threshold and the actual emissions for a given power level. At low power levels, the margin against the a priori defined emission mask may be significant, on the order of a large number of decibels (e.g., 8-9 dB). However, as the commanded power for an RF circuit progressively increases, the out of band emissions of the RF circuit increase due to non-linear distortion, and thus, the margin between the emission mask threshold and actual emissions decreases. Eventually, the mask margin of the RF circuit drops to 0 dB, at which point the RF circuit no longer complies with defined performance or regulatory metrics for a wireless device. Because aspects of the present disclosure may allow for accurate prediction of the performance characteristics of the RF circuit, aspects of the present disclosure may allow for the maximum allowable transmit power for which the RF circuit is configured to be significantly greater than the maximum allowable transmit power set by techniques in which a backoff margin is used to account for various uncertainties in an RF circuit or a sample thereof. For example, the maximum allowable transmit power using the techniques discussed herein may be 1.5 dB higher than the maximum allowable transmit power with a backoff margin. Thus, aspects of the present disclosure may allow for the RF performance of the device to be improved by allowing for operations with performance closer to the actual performance of the current device.

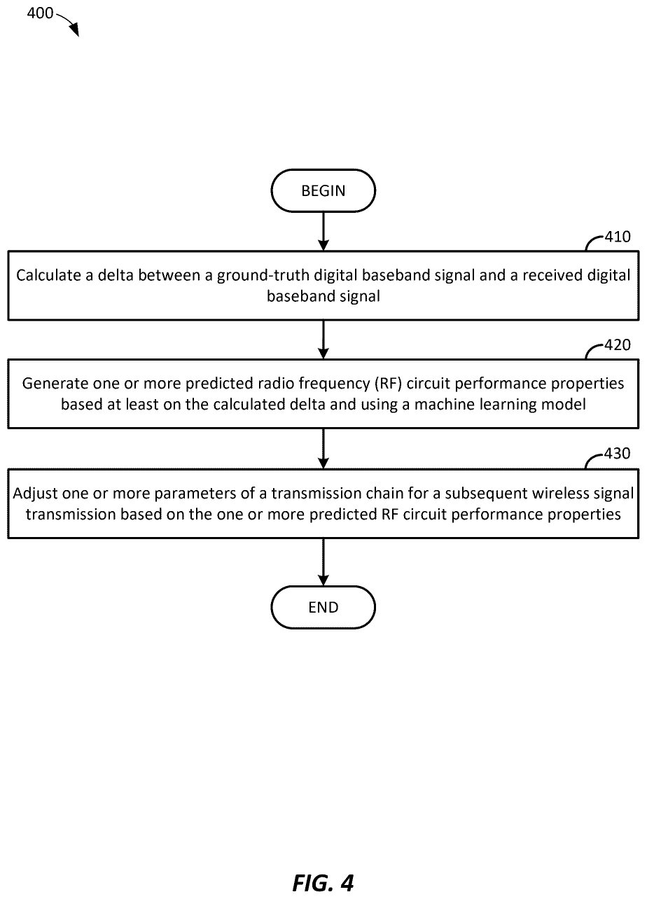

FIG. 4 illustrates example operations 400 that may be performed (e.g., by an RF circuit 200 illustrated in FIG. 2 or a controller associated therewith) to configure an RF circuit using machine-learning-model-based parameter calibration and a delta between ground-truth and received digital baseband signals, according to aspects of the present disclosure.

As illustrated, the operations 400 may begin at block 410, with calculating a delta between a ground-truth digital baseband signal and a received digital baseband signal.

At block 420, the operations 400 proceed with generating one or more predicted radio frequency (RF) circuit performance properties based at least on the calculated delta and using a machine learning model.

At block 430, the operations 400 proceed with adjusting one or more parameters of a transmission chain for a subsequent wireless signal transmission based on the one or more predicted RF circuit performance properties.

In some aspects, adjusting the one or parameters of the transmission chain comprises adjusting parameters such that deltas between actual RF circuit performance properties associated with subsequent transmissions and threshold values for the RF circuit performance properties are minimized, or at least reduced. For example, the adjustment of the one or more parameters may be an additional amount of power used by a power amplifier (e.g., the power amplifier 218) to amplify a subsequent signal prior to transmission such that the difference between a predicted and threshold EVM (e.g., for high MCS values) or predicted and threshold spectral mask margins (e.g., for low MCS values) is minimized, or at least reduced. In doing so, the RF circuit may be configured to perform close to the highest achievable performance characteristics of the RF circuit, which may exceed a minimum guaranteed performance level for the design of the RF circuit.

In some aspects, the delta between the ground-truth digital baseband signal and the received digital baseband signal comprises a determination of an amount of distortion in the received digital baseband signal relative to the ground-truth digital baseband signal. The amount of distortion may be due to at least one of a time difference, a gain difference, or a phase difference between the ground-truth digital baseband signal and the received digital baseband signal.

In some aspects, the one or more predicted RF circuit performance properties comprise an error vector magnitude (EVM) prediction (e.g., the EVM estimate 232).

In some aspects, the one or more predicted RF circuit performance properties comprise a spectral mask margin prediction (e.g., the estimated spectral mask margin 234).

In some aspects, the one or more predicted RF circuit performance properties comprise an emission prediction (e.g., the estimated RF emissions 236).

In some aspects, the one or more parameters of the transmission chain comprise an amount of amplification applied to an RF signal based on a predistorted digital baseband signal via the transmission chain for the subsequent wireless signal transmission.

In some aspects, the one or more parameters of the transmission chain comprise one or more parameters of a digital predistorter (e.g., the DPD 212) in the transmission chain.

In some aspects, the one or more parameters of the transmission chain comprise one or more parameters based on which the digital baseband signal is generated by a baseband processor.

In some aspects, the received digital baseband signal comprises a signal received from a feedback receive chain (e.g., the FBRX 206) based on a processed version of the ground-truth baseband signal via the transmission chain.

In some aspects, the received digital baseband signal comprises a defined signal received from an adjacent node. Information about a delta between an a priori known version of the defined signal and the received version of the defined signal may be used by the RF circuit to estimate the RF circuit performance properties of an RF transmission chain at a neighboring node (e.g., the node from which the defined signal is received). The estimated RF circuit performance properties may be fed back to the neighboring node for the neighboring node to use in adjusting the properties of the transmit chain at the neighboring node (e.g., using the techniques discussed herein).

### Example Processing Systems for Configuring RF Circuits Using Machine Learning Models

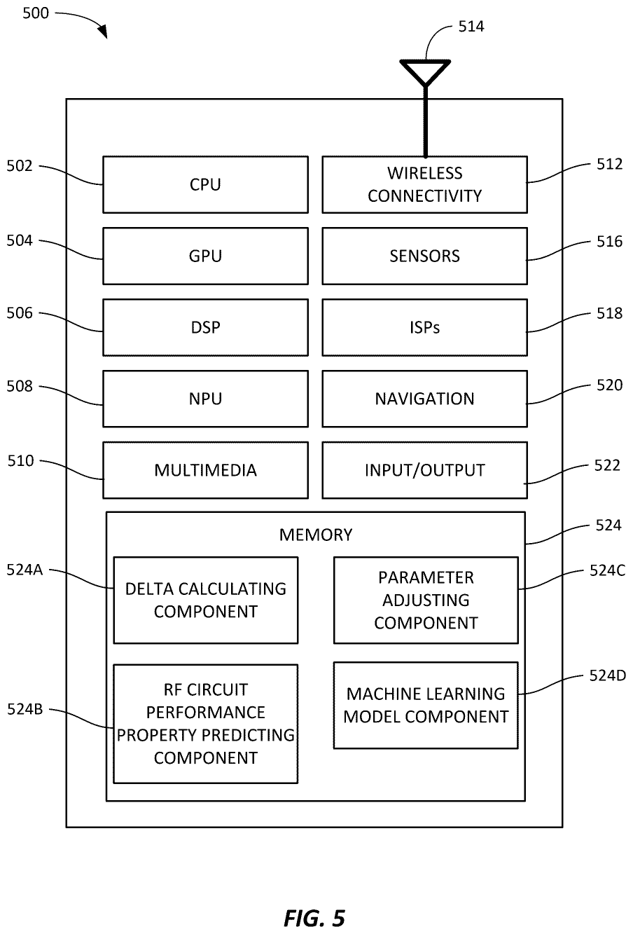

FIG. 5 depicts an example processing system 500 for calibrating an RF circuit using machine-learning-model-based parameter calibration and a delta between ground-truth and received digital baseband signals, such as described herein for example with respect to FIG. 4.

Processing system 500 includes a central processing unit (CPU) 502, which in some examples may be a multi-core CPU. Instructions executed at the CPU 502 may be loaded, for example, from a program memory associated with the CPU 502 or may be loaded from memory 524.

Processing system 500 also includes additional processing components tailored to specific functions, such as a graphics processing unit (GPU) 504, a digital signal processor (DSP) 506, a neural processing unit (NPU) 508, a multimedia processing unit 510, and a wireless connectivity component 512.

An NPU, such as NPU 508, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as NPU 508, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 508 is a part of one or more of CPU 502, GPU 504, and/or DSP 506.

In some examples, the wireless connectivity component 512 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 512 is further coupled to one or more antennas 514.

The processing system 500 may also include one or more sensor processing units 516 associated with any manner of sensor, one or more image signal processors (ISPs) 518 associated with any manner of image sensor, and/or a navigation processor 520, which may include satellite-based positioning system components (e.g., GPS or GLONASS) as well as inertial positioning system components.

The processing system 500 may also include one or more input and/or output devices 522, such as screens, touch-sensitive surfaces (including touch-sensitive displays), physical buttons, speakers, microphones, and the like.

In some examples, one or more of the processors of processing system 400 may be based on an ARM or RISC-V instruction set.

Processing system 500 also includes memory 524, which is representative of one or more static and/or dynamic memories, such as a dynamic random access memory, a flash-based static memory, and the like. In this example, memory 524 includes computer-executable components, which may be executed by one or more of the aforementioned processors of processing system 500. In particular, in this example, memory 524 includes a delta calculating component 524A, an RF circuit performance property predicting component 524B, a parameter adjusting component 524C, a machine learning model component 524D, and other components not depicted, which may be configured to perform various aspects of the methods described herein.

### Example Clauses

Implementation details of various aspects are described in the following numbered clauses.

Clause 1: A method for wireless communication, comprising: calculating a delta between a ground-truth digital baseband signal and a received digital baseband signal; generating one or more predicted radio frequency (RF) circuit performance properties based at least on the calculated delta and using a machine learning model; and adjusting one or more parameters of a transmission chain for a subsequent wireless signal transmission based on the one or more predicted RF circuit performance properties.

Clause 2: The method of Clause 1, wherein adjusting the one or parameters of the transmission chain comprises adjusting parameters such that deltas between actual RF circuit performance properties associated with subsequent transmissions and threshold values for the RF circuit performance properties are minimized.

Clause 3: The method of Clause 1 or 2, wherein the delta between the ground-truth digital baseband signal and the received digital baseband signal comprises a determination of an amount of distortion in the received digital baseband signal relative to the ground-truth digital baseband signal.

Clause 4: The method of Clause 3, wherein the amount of distortion comprises at least one of a time difference, a gain difference, or a phase difference between the ground-truth digital baseband signal and the received digital baseband signal.

Clause 5: The method of any of Clauses 1 through 4, wherein the one or more predicted RF circuit performance properties comprise an error vector magnitude (EVM) prediction.

Clause 6: The method of any of Clauses 1 through 5, wherein the one or more predicted RF circuit performance properties comprise a spectral mask margin prediction.

Clause 7: The method of any of Clauses 1 through 6, wherein the one or more predicted RF circuit performance properties comprise an emission prediction.

Clause 8: The method of any of Clauses 1 through 7, wherein the one or more parameters of the transmission chain for the subsequent wireless signal transmission comprise an amount of amplification applied to an RF signal based on a predistorted digital baseband signal.

Clause 9: The method of any of Clauses 1 through 8, wherein the one or more parameters of the transmission chain comprise one or more parameters of a digital predistorter in the transmission chain.

Clause 10: The method of any of Clauses 1 through 9, wherein the one or more parameters of the transmission chain comprise one or more parameters based on which the ground-truth digital baseband signal is generated by a baseband processor.

Clause 11: The method of any of Clauses 1 through 10, wherein the received digital baseband signal comprises a signal received from a feedback receive chain based on a processed version of the ground-truth baseband signal via the transmission chain.

Clause 12: An apparatus, comprising: a memory having executable instructions stored thereon; and one or more processors collectively configured to execute the executable instructions to cause the apparatus to perform a method in accordance with any of Clauses 1 through 11.

Clause 13: An apparatus comprising means for performing a method in accordance with any of Clauses 1 through 11.

Clause 14: A non-transitory computer-readable medium having instructions stored thereon which, when executed by a processor, perform a method in accordance with any of Clauses 1 through 11.

Clause 15: A computer program product embodied on a computer-readable storage medium comprising code for performing a method in accordance with any of Clauses 1 through 11.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications, comprising:
calculating a delta between a ground-truth digital baseband signal and a received digital baseband signal;
generating one or more predicted radio frequency (RF) circuit performance properties based at least on the calculated delta and using a machine learning model; and
adjusting one or more parameters of a transmission chain for a subsequent wireless signal transmission based on the one or more predicted RF circuit performance properties.

2. The method of claim 1, wherein adjusting the one or more parameters of the transmission chain comprises adjusting parameters such that deltas between actual RF circuit performance properties associated with subsequent transmissions and threshold values for the RF circuit performance properties are minimized.

3. The method of claim 1, wherein the delta between the ground-truth digital baseband signal and the received digital baseband signal comprises a determination of an amount of distortion in the received digital baseband signal relative to the ground-truth digital baseband signal.

4. The method of claim 3, wherein the amount of distortion comprises at least one of a time difference, a gain difference, or a phase difference between the ground-truth digital baseband signal and the received digital baseband signal.

5. The method of claim 1, wherein the one or more predicted RF circuit performance properties comprise an error vector magnitude (EVM) prediction.

6. The method of claim 1, wherein the one or more predicted RF circuit performance properties comprise a spectral mask margin prediction.

7. The method of claim 1, wherein the one or more predicted RF circuit performance properties comprise an emission prediction.

8. The method of claim 1, wherein the one or more parameters of the transmission chain for the subsequent wireless signal transmission comprise an amount of amplification applied to an RF signal based on a predistorted digital baseband signal.

9. The method of claim 1, wherein the one or more parameters of the transmission chain comprise one or more parameters of a digital predistorter in the transmission chain.

10. The method of claim 1, wherein the one or more parameters of the transmission chain comprise one or more parameters based on which the ground-truth digital baseband signal is generated by a baseband processor.

11. The method of claim 1, wherein the received digital baseband signal comprises a signal received from a receive chain based on a processed version of the ground-truth digital baseband signal via the transmission chain.

12. An apparatus for wireless communications, comprising:
a radio frequency (RF) circuit comprising a transmission chain and a receive chain;
at least one memory having executable instructions stored thereon; and
one or more processors configured to execute the executable instructions to cause the apparatus to:
calculate a delta between a ground-truth digital baseband signal and a digital baseband signal received via the RF circuit;
generate one or more predicted RF circuit performance properties based at least on the calculated delta and using a machine learning model; and
adjust one or more parameters of the transmission chain of the RF circuit for a subsequent wireless signal transmission based on the one or more predicted RF circuit performance properties.

13. The apparatus of claim 12, wherein to adjust the one or more parameters of the transmission chain, the one or more processors are configured to adjust parameters such that deltas between actual RF circuit performance properties associated with subsequent transmissions and threshold values for the RF circuit performance properties are minimized.

14. The apparatus of claim 12, wherein the delta between the ground-truth digital baseband signal and the received digital baseband signal comprises a determination of an amount of distortion in the received digital baseband signal relative to the ground-truth digital baseband signal.

15. The apparatus of claim 14, wherein the amount of distortion comprises at least one of a time difference, a gain difference, or a phase difference between the ground-truth digital baseband signal and the received digital baseband signal.

16. The apparatus of claim 12, wherein the one or more predicted RF circuit performance properties comprise an error vector magnitude (EVM) prediction.

17. The apparatus of claim 12, wherein the one or more predicted RF circuit performance properties comprise a spectral mask margin prediction.

18. The apparatus of claim 12, wherein the one or more predicted RF circuit performance properties comprise an emission prediction.

19. The apparatus of claim 12, wherein the one or more parameters of the transmission chain for the subsequent wireless signal transmission comprise an amount of amplification applied to an RF signal based on a predistorted digital baseband signal.

20. The apparatus of claim 12, wherein the transmission chain comprises a digital predistorter and wherein the one or more parameters of the transmission chain comprise one or more parameters of the digital predistorter in the transmission chain.

21. The apparatus of claim 12, wherein the one or more parameters of the transmission chain comprise one or more parameters based on which the digital baseband signal is generated by a baseband processor.

22. The apparatus of claim 12, wherein the ground-truth digital baseband signal comprises a signal output by the RF circuit.

23. An apparatus for wireless communications, comprising:
means for calculating a delta between a ground-truth digital baseband signal and a received digital baseband signal;
means for generating one or more predicted radio frequency (RF) circuit performance properties based at least on the calculated delta and using a machine learning model; and
means for adjusting one or more parameters of a transmission chain for a subsequent wireless signal transmission based on the one or more predicted RF circuit performance properties.

24. The apparatus of claim 23, wherein the means for adjusting the one or more parameters of the transmission chain comprises means for adjusting parameters such that deltas between actual RF circuit performance properties associated with subsequent transmissions and threshold values for the RF circuit performance properties are minimized.

25. The apparatus of claim 23, wherein the delta between the ground-truth digital baseband signal and the received digital baseband signal comprises a determination of an amount of distortion in the received digital baseband signal relative to the ground-truth digital baseband signal.

26. The apparatus of claim 23, wherein the one or more predicted RF circuit performance properties comprise at least one of an error vector magnitude (EVM) prediction, a spectral mask margin prediction, or an emission prediction.

27. The apparatus of claim 23, wherein the one or more parameters of the transmission chain for the subsequent wireless signal transmission comprise one or more of:
an amount of amplification applied to an RF signal based on a predistorted digital baseband signal, or
one or more parameters of a digital predistorter in the transmission chain.

28. The apparatus of claim 23, wherein the one or more parameters of the transmission chain comprise one or more parameters based on which the ground-truth digital baseband signal is generated by a baseband processor.

29. The apparatus of claim 23, wherein the received digital baseband signal comprises a signal received from a receive chain based on a processed version of the ground-truth digital baseband signal via the transmission chain.

30. A non-transitory computer-readable medium having executable instructions stored thereon which, when executed by one or more processors, perform an operation, the operation comprising:
calculating a delta between a ground-truth digital baseband signal and a received digital baseband signal;
generating one or more predicted radio frequency (RF) circuit performance properties based at least on the calculated delta and using a machine learning model; and
adjusting one or more parameters of a transmission chain for a subsequent wireless signal transmission based on the one or more predicted RF circuit performance properties.
